(19) United States
(12) Patent Application Publication
(10) Pub. No.: US 2016/0245747 A1
(43) Pub. Date: Aug. 25, 2016

(54) OPTICAL SENSOR ARRANGEMENT FOR MONITORING CRYOGENIC FLUID

(71) Applicant: UNIVERSITY OF LJUBLJANA, Ljubljana (SI)

(72) Inventors: Franci PUSAVEC, Trzic (SI); Uros ALJANCIC, Trzic (SI); Janez KOPAC, Domzale (SI); Slavko AMON, Ljubljana (SI)

(21) Appl. No.: 15/026,047

(22) PCT Filed: Sep. 23, 2014
(86) PCT No.: PCT/EP2014/070212

§ 371 Date: Mar. 30, 2016

(30) Foreign Application Priority Data
Sep. 30, 2013 (SI) P-201300296

(51) Int. Cl. G01N 21/59; G05D 7/06; B23Q 11/10

(52) U.S. Cl. CPC G01N 21/59; B23Q 11/1038; B23Q 11/1053; G05D 7/0617

(57) ABSTRACT

The invention relates to the use of an optical phase detection sensor arrangement (1) for detecting the phase of a cryogenic fluid (2) in a conduit of a cryogenic light fluid delivery system, said phase detection sensor arrangement comprising: an inlet port (3) for receiving cryogenic fluid; an outlet port (4) for releasing cryogenic fluid; a first connecting portion (5) for connection to a light source (6); a second connecting portion (7) for connection to a light sink (8); a housing (9); and a measurement chamber (10) provided in said housing between, and preferably in fluid communication with, said inlet port and said outlet port; wherein said first and second connecting portions are arranged in said housing so that said light source and said light sink, when connected to said first and second connecting portions, are arranged such that light can be emitted from said light source into said measurement chamber, and said emitted light can be received by said light sink.

### FIELD OF THE INVENTION

The present invention is in the field of cryogenic machining More specifically, the present invention relates to methods and systems for the delivery of cryogenic fluid to machine tools, and to sensor arrangements for the detection of the phase of a cryogenic fluid upon delivery.

### BACKGROUND OF THE INVENTION

In conventional machining processes, due to the inherent nature of the process, machining tools are not only subjected to significant mechanical stress, but they are also exposed to very high temperatures. In order to circumvent problems associated with high temperatures, conventional machining processes apply cooling fluids to cool the cutting tools, for example, cooling lubrication fluids (CLFs). Such CLFs may be, for example oil-based cooling fluids, emulsions, or similar fluids having lubrication properties and, most importantly, a relatively high specific cooling capacity.

As an alternative to oil-based CLFs, the use of liquid nitrogen as a cooling fluid has been proposed. WO96/05008, e.g., discloses a cryogenic machining processes using liquid nitrogen as the cooling fluid. Liquid nitrogen (N₂) has a low evaporation temperature (boiling point) of −196° C. at atmospheric pressure, which confers excellent cooling characteristics. When delivering liquid nitrogen from a storage container, such as Dewar vessel, to a machining tool—due to the large temperature difference between the cooling fluid and the ambient air, and due to incomplete insulation—significant thermal losses are likely to occur. The thermal losses lead to an increase of the temperature of the cooling fluid upon transport, which cooling fluid then tends to evaporate within the conduit through which the liquid nitrogen is transported. Depending on the extent of temperature loss, all or only parts thereof may evaporate. This often leads to the delivery of the cryogenic fluid in a mixed phase (e.g., liquid nitrogen with gas bubbles, or gaseous nitrogen with liquid droplets). While the delivery of the cryogenic fluid in form of a mixed gas/liquid fluid phase is sometimes advantageous, generally delivery in liquid form is preferred. The liquid phase normally has a lower temperature, a greater cooling capacity and better lubricating properties than has the cryogenic fluid in gas phase. Cryogenic fluids in liquid form thus lead to reduced wear of the cutting tools, and ultimately to more economic machining processes. Hence, the ability to control the relative amount of gas and liquid cooling fluid delivered is desired.

In order to enable control of the phase status in which cryogenic fluid is delivered, it is generally advantageous to be able to detect the phase of the cryogenic fluid upon delivery and, e.g. the amount of gas phase (bubbles) in the delivered cryogenic fluid. Detection of the phase of the cryogenic fluid allows controlling other process parameters, for example, the mass flow of cryogenic fluid through the delivery system. The mass flow has an impact on the relative amounts of gas and liquid of the cryogenic fluid delivered to the machining tool, as will be explained below.

Sensors for the detection of the phase of a cryogenic fluid in cryogenic fluid delivery systems have been proposed. Known sensors and systems for the determination of the phase of cryogenic fluid generally rely on temperature measurements or on capacitive measurements. These detection principles, however, are not ideal.

Temperature sensors are relatively slow, and therefore such sensors are unable to detect fast changes of the temperature of a cryogenic fluid. Fast detection of temperature changes, however, is required for the detection of a mixed gas/liquid phase of a cryogenic fluid. Hence, temperature sensors are often not able to detect the presence of such mixtures of gas/liquid fluid reliably. A further limitation of temperature sensors in the detection of the phase status of the cryogenic fluid stems from the fact that at and around the evaporation point of the cryogenic fluid, both liquid and the gaseous cryogenic fluid may be present. Hence, at and around the evaporation point of the cryogenic fluid, a temperature sensor does not provide the information needed for distinguishing between gaseous and liquid cryogenic fluid.

An alternative measurement principle for the determination of the fluid phase of a cryogenic fluid, suggested by the prior art, is based on capacitive sensors. Capacitive sensors are also used, e.g., to determine the level of liquid nitrogen in storage containers. Capacitive sensors, however, suffer from similar deficiencies as do temperature sensors. For example, capacitive sensors are also relatively slow. Hence, capacitive measurement systems are likewise unable to detect fast phase changes in the cryogenic fluid, such as encountered when a mixed gas/liquid cryogenic fluid is delivered to the machining tool.

Against the above described background, it is to provide sensors and measurement systems suitable for detecting the phase status of a cryogenic fluid in a cryogenic fluid delivery system, which sensors and measurement systems exhibit an improved response time and accuracy. A further object of the invention is to provide sensors and measurement systems capable of reliably detecting the phase status of a cryogenic fluid in and around its evaporation point.

It is another object of the invention to provide cryogenic fluid delivery systems in which the phase status of the cryogenic fluid upon delivery can more effectively and more accurately be detected and controlled.

### SUMMARY OF THE INVENTION

The above mentioned shortcomings of the prior art are ameliorated by sensor arrangements, systems and methods as defined in the appended claims. The invention also provides for the use of sensor arrangements, delivery systems, cryogenic machining systems, and for methods employing sensors and systems as defined in the claims.

The present invention thus relates to an optical phase detection sensor arrangement for detecting the phase of a cryogenic fluid in a conduit. The sensor arrangement comprises: an inlet port for receiving cryogenic fluid; an outlet port for releasing cryogenic fluid; a first connecting portion for connection to a light source; a second connecting portion for connection to a light sink; a housing; and a measurement chamber. The measurement chamber is preferably provided in said housing between (and preferably in fluid communication with) said inlet port and said outlet port. The first and second connecting portions are preferably arranged in said housing so that said light source and said light sink, when connected to said phase detection sensor arrangement, are arranged spaced-apart from each other in said measurement chamber.

Another aspect of the invention relates to an optical phase detection sensor arrangement for detecting the phase of a cryogenic fluid in a conduit (or for determining the amount of gaseous cryogenic fluid in a conduit), said phase detection sensor arrangement comprising: an inlet port for receiving cryogenic fluid; an outlet port for releasing cryogenic fluid; a first connecting portion for connection to a light source; a second connecting portion for connection to a light sink; a housing; and a measurement chamber provided in said housing between, and in fluid communication with, said inlet port and said outlet port; wherein said first and second connecting portions are arranged in said housing so that said light source and said light sink, when connected to said first and second connecting portions, are arranged such that light can be emitted from said light source into said measurement chamber, and said emitted light can be received (preferably, from said measurement chamber) by said light sink.

In one embodiment, said first and second connecting portions are in form of two separate connecting portions; and said light source and said light sink, when connected to said first and second connecting portions, respectively, are arranged spaced apart from each other in said measurement chamber.

In a further preferred embodiment, said light source and said light sink, when connected to said first and second connecting portions, respectively, are provided in said housing at opposite sides of said measurement chamber.

In an alternative embodiment, said first and second connecting portions are in form of a single connecting portion connectable to said light source and to said light sink. This embodiment is particularly useful when the phase of the cryogenic fluid is to be detected in reflective mode, e.g., when the light source and light sink are not arranged in a face-to-face relationship. For the detection of the phase of the cryogenic fluid in reflective mode, it is however not required that the first and second connecting portions are the same connecting portion. Other configurations are envisaged. For example, the first and second connecting portions may be arranged next to each other in a parallel orientation, facing in the same direction. Alternatively, first and second connecting portions can be arranged at an angle to each other. For detection of the phase of the cryogenic fluid in reflective mode, a reflecting surface, such as a mirror, may be provided opposite the first and second connecting portions, i.e., opposite the light source and light sink, when connected to the first and second connecting portions.

In other preferred sensor arrangement of the invention said light source and light sink, when connected to said first and second connecting portions, respectively, are provided in said housing at opposite sides (e.g., at opposite inner surfaces) of said measurement chamber. Alternatively, light source and light sink may be arranged in said housing in a face-to-face relationship. Alternatively, light source and light sink are arranged in said housing so that light emitted by said light source into said measurement chamber can be received by said light sink.

In a preferred embodiment of the invention, the light source comprises a laser or a light-emitting diode (LED). The laser or LED is preferably connected to said first connecting portion, e.g., via a an optical fiber.

The light sink may comprise a light detector for detecting light emitted from said light source and is preferably connected to the second connecting portion. The detector may advantageously be connected to said second connecting portion, e.g., via an optical fiber.

Hence, according to the invention, said light source may further comprise an optical fiber connected between said first connecting portion and said laser or LED.

The light sink may further comprise an optical fiber connected between said second connecting portion and said detector.

In preferred embodiments, the sensor arrangement further comprises means for recording the intensity of light detected by the detector. Suitable means for recording the intensity of light detected by the detector are, e.g., data storage means, such as a hard disk or other computer memory.

According to one embodiment, the sensor arrangement further comprises computing means for computing the phase of a cryogenic fluid from the intensity of the light detected by the detector. Suitable computing means may be conventional computers or CPUs appropriately programmed to compute the phase of the cryogenic fluid from of the intensity of the light detected by the detector.

The invention further relates to a cryogenic fluid delivery system comprising a source of cryogenic fluid, such as a Dewar vessel, a conduit connected to said source of cryogenic fluid and an optical sensor arrangement connected to, or provided in, said conduit. The optical sensor arrangement is preferably one according to the invention as described herein above.

Another aspect of the invention relates to system for cryogenic machining, the system comprising a machining tool connected to the cryogenic delivery system of the invention, as described herein above.

The present invention also relates generally to the use of optical sensors for detecting the phase of a cryogenic fluid in a conduit of a cryogenic fluid delivery system.

In preferred embodiments, the optical sensor is a sensor arrangement of the invention, as described herein above. Hence, an aspect of the invention relates to the use of an optical phase detection sensor arrangement for detecting the phase of a cryogenic fluid in a conduit (or for determining the amount of gaseous cryogenic fluid in a conduit), said phase detection sensor arrangement comprising: an inlet port for receiving cryogenic fluid; an outlet port for releasing cryogenic fluid; a first connecting portion for connection to a light source; a second connecting portion for connection to a light sink; a housing; and a measurement chamber provided in said housing between, and in fluid communication with, said inlet port and said outlet port; wherein said first and second connecting portions are arranged in said housing so that said light source and said light sink, when connected to said first and second connecting portions, are arranged such that light can be emitted from said light source into said measurement chamber, and said emitted light can be received by said light sink.

A further aspect of the invention relates to a method of detecting the phase of a cryogenic fluid in a conduit of a cryogenic fluid delivery system, said method comprising detecting the phase of said cryogenic fluid in said conduit with a sensor arrangement of the invention as described herein above.

The invention also relates to methods of controlling the mass flow of cryogenic fluid through a cryogenic fluid delivery system, wherein the mass flow is controlled on the basis of a signal detected by a sensor arrangement of the invention as described herein above.

In preferred embodiments of the invention, the “detection of the phase” of a cryogenic fluid shall be understood comprising a determination of the amount of (or relative amount of) gas phase in the cryogenic fluid in the conduit. The “detection of the phase” may also comprise the detection of (or determination of the amount of) gas bubbles in the cryogenic fluid in the conduit.

### BRIEF DESCRIPTION OF THE FIGURES

FIG. 1 shows a phase detection sensor arrangement according to the invention.

FIG. 2 shows a phase detection sensor arrangement according to the invention, integrated in a spray nozzle.

FIG. 3 shows a photograph of a sensor arrangement according to the invention.

FIG. 4 shows measurements from an optical sensor arrangement according to the invention and measurements from a temperature sensor.

### DETAILED DESCRIPTION OF THE INVENTION

The present invention is based on the significant finding that the fluid phase of a cryogenic fluid in a conduit of a cryogenic fluid delivery system can reliably be determined by optical sensors. The present inventors have found that the optical detection of a cryogenic fluid by measuring a reduction of the light intensity after transmission of the light through the cryogenic fluid can provide very fast and accurate information on the phase status of the cryogenic fluid.

The invention thus relates to optical phase detection sensor arrangements. Sensor arrangements of the present invention preferably measure the reduction in light intensity when light is transmitted from a light source through a cryogenic fluid to a light sink, preferably, in a measurement chamber. The optical phase detection sensor arrangements of the invention provide short response times of preferably less than 10 ms. Another advantageous feature of sensor arrangements of the invention is that they can be constructed in miniaturized form, which allows integration of the sensor arrangement, e.g., with a fluid delivery nozzle. The sensor arrangements of the invention when arranged in (or in line with) a conduit preferably produce a minimum of disturbance of the fluid flow in the conduit. Hence, they are designed to produce a minimum of turbulence. This is advantageous, because turbulence may lead to undesired evaporation of the cryogenic fluid in the conduit. Sensor arrangements of the present invention hence reduce evaporation of the cooling fluid in the conduit. The sensor arrangements of the present invention are preferably very small and thereby able to detect the phase of the cooling fluid in conduits having a diameter equal to or below, e.g., 1 mm.

Sensor arrangements and systems of the present invention preferably detect and/or quantify the relative amounts of gaseous and liquid cryogenic fluid in the delivery conduit, and are preferably able to express the relative amounts in percent gas or liquid in the cryogenic fluid flow.

Phase detection sensor arrangements according to the invention may further comprise recording means for recording the output of the detector. Recording means may be conventional computers, microcontrollers, and the like, preferably connected to a mass storage device, such as a hard disk or a computer memory.

In preferred embodiments of the invention, the phase detection sensor arrangement is mounted at, or in close proximity to, a delivery nozzle. This ensures that the fluid phase detected by the sensor arrangement accurately corresponds to the fluid phase effective at the cutting zone. In preferred embodiments, the sensor arrangement of the invention is integral with a delivery nozzle of a machining tool.

Detection of the fluid phase, according to the invention, is based on the reduction of light intensity of light transmitted through the cryogenic fluid. The intensity of light transmitted through the cryogenic fluid is reduced according to the Lambert-Beer law and/or through light scattering. Since, the reduction of the light intensity according to the Lambert-Beer law and through light scattering is stronger with the liquid cryogenic fluid as compared to the gaseous cryogenic fluid, the intensity of the light detected by the detector provides useful information on the phase of the cryogenic liquid, and thus on the relative amount of gaseous cryogenic fluid in the conduit.

The intensity of light transmitted through the cryogenic fluid can be measured in transmissive mode (as described above), or it can be measured in reflective mode. In the reflective mode, light source and light sink are not arranged in a face-to-face relationship, but they are arranged such that they face either in the same direction, or they are arranged at an angle. Hence, light source and light sink may be arranged next to each other, facing the same direction, or even the same optical fiber can be used for the light source and the light sink. In this case, the single optical fiber is connected to both a laser (or LED or other source of light) and to the light sensitive detector. The same optical fiber can then serve as light source and light sink. When measuring in the reflective mode, it is advantageous to provide a reflecting surface, or a mirrow, opposite the light source and light sink.

The sensor arrangements of the present invention are used in cryogenic fluid delivery systems. Such systems may comprise a source of cryogenic fluid, such as a Dewar vessel, a conduit for delivering cryogenic fluid to the machining tool, the machining tool itself, and an optical phase detection sensor arrangement, preferably one according to the invention.

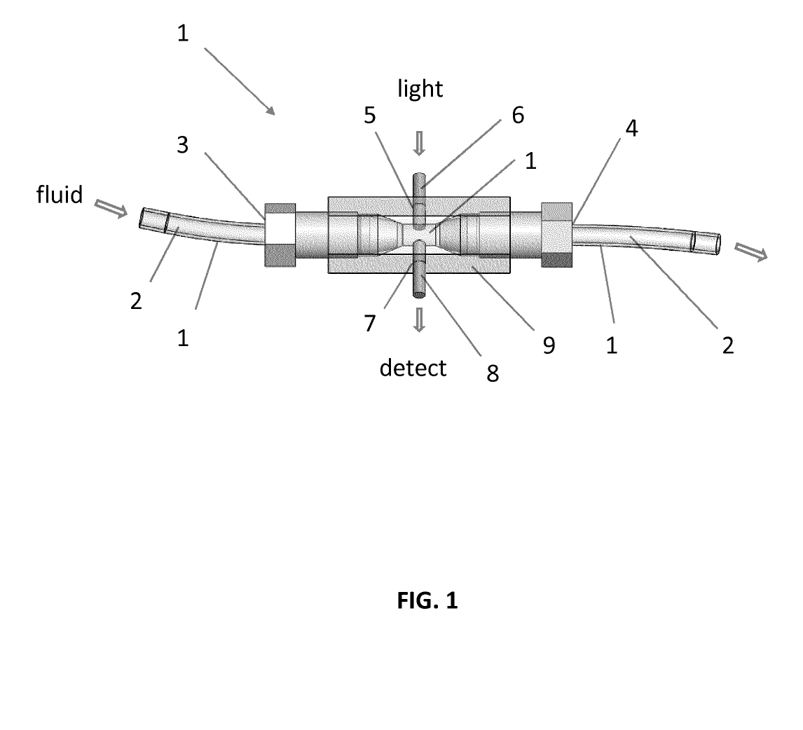

FIG. 1 shows an optical phase detection sensor arrangement 1 having an inlet port 3 for cryogenic fluid 2, an outlet port 4, and a measurement chamber 10. Measurement chamber 8 is provided in a housing 9 and arranged in fluid communication with inlet port 3 and outlet port 4. More specifically, measurement chamber 10 is provided in fluid communication with, and in between, inlet port 3 and outlet port 4. Cryogenic fluid flowing from inlet port 3 to outlet port 4 thus flows through measurement chamber 10. As can be seen in the Figure, inlet port 3 is in this embodiment connected to a first portion of a delivery pipe or conduit 11, whereas the outlet port 4 is connected to a second portion of the same conduit 11.

The phase detection sensor arrangement 1 further includes a first connecting portion 5 for connection to a light source 6, and a second connecting portion 7 for connection to a light sink 8. First and second connecting portions 5 and 7, in this embodiment, are provided in form of holes in housing 9, into which holes optical fibers (which may be considered part of the light source and/or light sink) are introduced. Other connecting mechanisms of light source 6 and light sink 8 to housing 9, or measurement chamber 10, are of course possible.

An optical fiber, according to the invention, is any flexible fiber made of a transparent material, such as, e.g., extruded glass (silica) or a transparent polymer. Suitable optical fibers may be fibers made from PMMA, i.e., acrylic glass.

Light source 6 and light sink 8 are preferably arranged in housing 9 or in sensor arrangement 1 in a face-to-face relationship. In other words, light emitted by light source 6 into measurement chamber 10 can be received by light sink 8, and then delivered to a photo detector.

Light sources according to the invention preferably comprise a laser or light emitting diodes (LEDs). The laser and/or LED may be connected to, or coupled to, measurement chamber 10 by an optical fiber. Specifically, the optical fiber is connected in a fluid-tight manner with housing 9 of sensor arrangement 1 by means of a hole provided in housing 9. As can be seen in the Figure, a distal end of the optical fiber preferably extends to an inner surface of measurement chamber 10. However, the distal end may also protrude into measurement chamber 10. In other configurations, the laser or LED may be provided directly at, or at a surface of, measurement chamber 10.

The invention also relates to cryogenic delivery systems. Cryogenic delivery systems according to the invention include a conduit 11, which is preferably connected to a source of cryogenic fluid (not shown), such as an insulated container or a Dewar vessel. The source of cryogenic fluid is in fluid communication with conduit 11. The conduit serves to transport cryogenic fluid from said source of cryogenic fluid ultimately to the machining tool. Preferably, the cryogenic fluid enters conduit 11 in liquid form. The cryogenic fluid is transported through conduit 11 by conventional means known to the person skilled in the art, e.g., by application of a pressure.

When advancing through conduit 11, due to unavoidable thermal losses, cryogenic fluid 2 in conduit 11 tends to increase in temperature. When the temperature of the cryogenic fluid exceeds the evaporation temperature (at local pressure) the phase of the cryogenic fluid may change from liquid phase to gas phase. This, in turn, leads to a mixture of gaseous and liquid cryogenic fluid in conduit 11. This mixture of gaseous and liquid cryogenic fluid advances through conduit 11 and through connected phase detection sensor arrangement 1. Cryogenic fluid 2 present in measurement chamber 10 of sensor arrangement 1 decreases the intensity of light emitted by light source 6 as it is received by light sink 8. Depending on the phase status of the cryogenic fluid in measurement chamber 10, i.e., depending on whether the cryogenic fluid is in gas phase or in liquid phase, the intensity of the light received by light sink 8 differs. If cryogenic fluid is present in liquid form, the intensity of the light received by light sink 8 will generally be lower than if cryogenic fluid is present in gaseous form. The intensity of the light received by light sink 8 and its connected detector can thus be used to establish the phase status of the cryogenic fluid.

Suitable detectors for detecting the intensity of the light received by light sink 8 are, e.g., silicon photo detectors. Suitable detectors are known to the person skilled in the art and/or commercially available. The detector is advantageously connected to, or coupled to, the measurement chamber by an optical fiber. The use of optical fibers not only allows for miniaturization of the phase detection sensor, but it also provides for spatial separation of the cryogenic fluid and the detector. This is advantageous, in particular, since conventional photo detectors will not operate properly at the very low temperatures present close to the point of measurement.

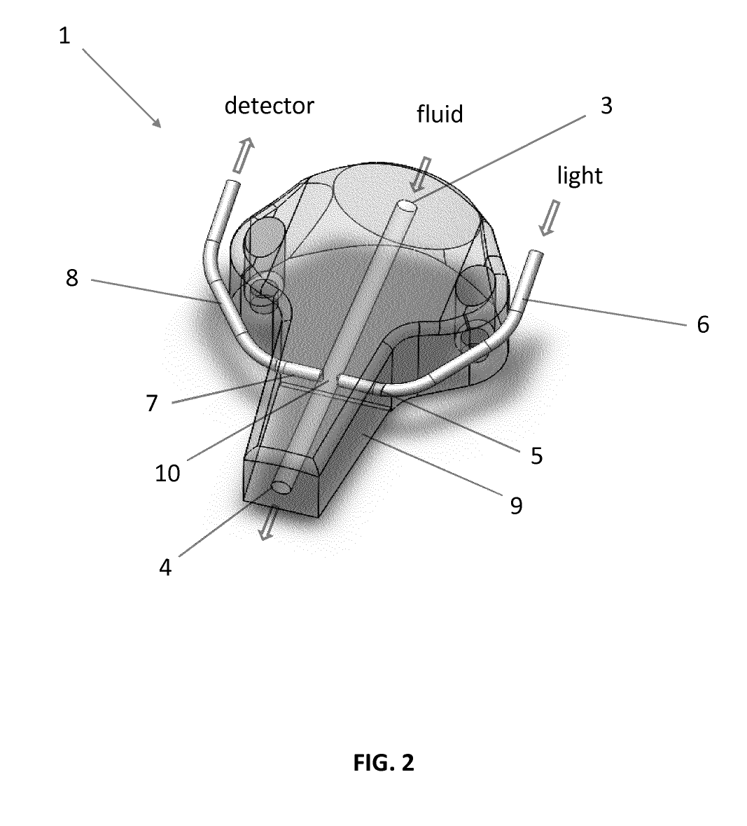

FIG. 2 shows another phase detection sensor arrangement according to the invention. In this case, phase detection sensor arrangement 1 is included in, i.e., is integral with, a delivery nozzle used to deliver (by spraying) cryogenic fluid directly to the cutting zone of a machining tool. Also in this embodiment, phase detection sensor arrangement 1 includes an inlet port 3 for cryogenic fluid, an outlet port 4, and a measurement chamber 10. Measurement chamber 10, in this embodiment, is in the form of a bore in the delivery nozzle. Inlet port 3 may be connected to a conduit delivering the cryogenic fluid (not shown). Outlet port 4, in this case, includes a nozzle which—upon operation—releases cryogenic fluid towards the cutting zone of the machining tool. Optical fibers are connected to housing 9 at connecting portions 5 and 7. End portions of the optical fibers are arranged in a face-to-face relationship in, or at a surface of, measurement chamber 10. Incident light from a laser or from an LED is led through the optical fiber (which is in this case considered part of the light source) into measurement chamber 10. Light is then transmitted through the cryogenic fluid in the measurement chamber and received by a second optical fiber. The second optical fiber is connected to a photo detector. Cryogenic fluid present in measurement chamber 10 decreases the intensity of light received by light sink 10 or its detector, thereby providing information on the phase of the cryogenic fluid in conduit 11 and/or measurement chamber 10.

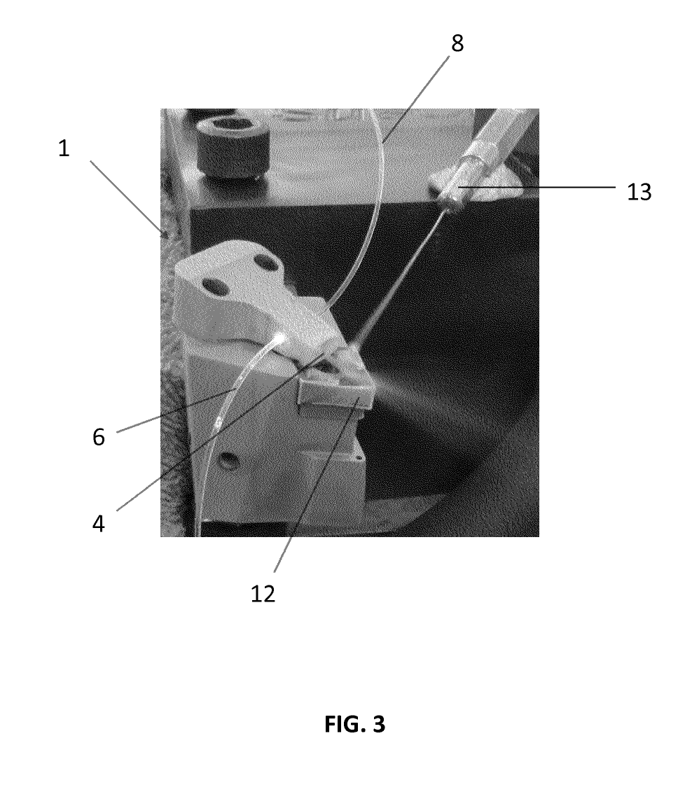

FIG. 3 is a photograph of a prototype sensor arrangement according to the invention. The sensor is mounted on a cutting tool 12 of a cryogenic machining system, and arranged to spray cryogenic fluid through the outlet port or nozzle 4. An LED (not shown) is connected to sensor arrangement 1 via an optical fiber. A second optical fiber serves as a light sink transporting received light from the measurement chamber to a detector (also not shown). Furthermore, there is provided an alternative sensor 13 for sensing the phase of the cryogenic fluid, in this case, a temperature sensor. The temperature sensor 13 senses the temperature of the cryogenic fluid when sprayed out from the nozzle.

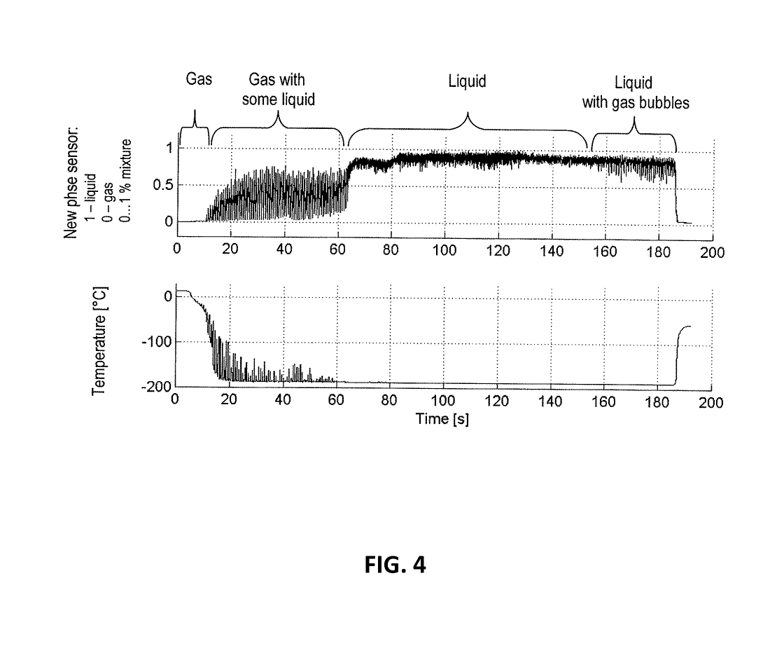

FIG. 4 shows measurements produced with the sensor arrangement shown in FIG. 3. The upper part of FIG. 4 shows the signal detected by an optical sensor according to the invention. In the lower part of the Figure is shown a signal obtained from a temperature sensor. The observed signals are discussed in the Examples section below.

The relative amount of gas and liquid cryogenic fluid can be calculated from the signal obtained from a sensor arrangement according to the invention. For example the accumulated time in which the optical signal is above a certain threshold may serve as a measure for the relative amount of fluid present in liquid form. Alternatively, an average signal intensity during a certain period of time may be calculated and interpreted as a measure for the relative amount of liquid in delivered cryogenic fluid. Suitable calibration methods are within the skill of the skilled person.

As will be appreciated, knowledge of the phase status of a fluid in a conduit or nozzle of a cryogenic delivery system is useful for controlling the flow of cryogenic fluid through the cryogenic fluid delivery system. In particular, a control loop can be provided which increases the flow of cryogenic fluid through conduit 11, when the proportion of cryogenic fluid in gaseous form is relatively large. Increasing the flow of cryogenic fluid through conduit 11 will then reduce the amount of cryogenic fluid present in gaseous form, hence increase the amount of cryogenic fluid delivered in liquid form.

One aspect of the invention also relates to methods for controlling the flow of cryogenic fluid through a cryogenic fluid delivery system. Hence, the current invention includes a method of controlling the mass flow of cryogenic fluid through a conduit of a cryogenic fluid delivery system, wherein the mass flow of cryogenic fluid is increased, when a detected relative amount of cryogenic fluid present in liquid form is less than a predetermined threshold, wherein the relative amount of cryogenic fluid present in liquid form is detected by a sensor arrangement according to the present invention. In a preferred embodiment, the (mass) flow of cryogenic fluid through the cryogenic fluid delivery system is controlled to assume the smallest possible level, at which level the cryogenic fluid is present substantially only in liquid form. This flow regime will minimize the overall consumption of cryogenic fluid.

### EXAMPLE

An optical phase detection sensor arrangement according to the invention was integrated in the delivery nozzle of a cryogenic machining tool (FIG. 3). The arrangement also includes a temperature sensor. The output signals of the optical sensor and of the temperature sensor were recorded in parallel, and are shown in FIG. 4. From t=0 to t=10 s only nitrogen gas was delivered to the nozzle. The output of the optical sensor is zero, indicating the absence of cryogenic fluid in liquid form. The temperature sensor detects a reduction of the temperature from room temperature to approximately −30° C. at t=10 s. From t=10 s to t=70 s, nitrogen gas and droplets of liquid nitrogen are delivered to the nozzle. The optical signal shows spikes indicating the alternating presence of liquid cryogenic fluid and gaseous cryogenic fluid in the conduit. Large signals indicate the presence of liquid in the measurement chamber, whereas low signals indicate the presence of gas. From t=70 s to t=160 s, substantially only liquid nitrogen is delivered. The optical sensor still provides a signal having a certain amount of fluctuation, however, e.g., the average signal intensity is relatively higher than in the previous phase (t=10 s to t=70 s). The temperature sensor indicates a constant temperature of −196° C., which is the evaporation temperature of the cryogenic fluid (liquid N₂). From t=160 s to t=185 s the cryogenic fluid is delivered in liquid form, but comprising gas bubbles. Gas bubbles are indicated by the optical sensor, whereas the temperature sensor is too slow to detect gas bubbles in the delivered cryogenic fluid.

It was hence found that the optical phase detection sensor according to the invention provided informative measurements for determining of the phase status of the cryogenic fluid in all phases of the experiment shown in FIG. 4. The temperature sensor, on the other hand, was unable to detect, e.g., the presence of gas bubbles in liquid cryogenic fluid. An optical fluid phase detection sensor arrangement according to the invention is useful to determine the phase status of the cryogenic fluid in a conduit or nozzle of a cryogenic delivery system. This was not possible using temperature sensors, as suggested in the prior art.

### REFERENCE NUMERALS

1—Phase detection sensor arrangement
2—Cryogenic fluid
3—Inlet port
4—Outlet port
5—First connecting portion
6—Light source
7—Second connecting portion
8—Light sink
9—Housing
10—Measurement chamber
11—Conduit
12—Cutting tool
13—Temperature sensor

1. An optical phase detection sensor arrangement for detecting the phase of a cryogenic fluid in a conduit, said phase detection sensor arrangement comprising:
an inlet port for receiving cryogenic fluid;
an outlet port for releasing cryogenic fluid;
a first connecting portion for connection to a light source;
a second connecting portion for connection to a light sink;
a housing; and
a measurement chamber provided in said housing between, and in fluid communication with, said inlet port and said outlet port;
wherein said first and second connecting portions are arranged in said housing so that said light source and said light sink, when connected to said first and second connecting portions, are arranged such that light can be emitted from said light source into said measurement chamber, and said emitted light can be received by said light sink.

2. The sensor arrangement of claim 1, wherein said first and second connecting portions are in form of two separate connecting portions; and said light source and said light sink, when connected to said first and second connecting portions, respectively, are arranged spaced apart from each other in said measurement chamber.

3. The sensor arrangement of claim 2, wherein said light source and said light sink, when connected to said first and second connecting portions, respectively, are provided in said housing at opposite sides of said measurement chamber.

4. The sensor arrangement of claim 1, wherein said first and second connecting portions are in form of a single connecting portion connectable to said light source and to said light sink.

5. The sensor arrangement of claim 1, wherein said light source comprises a laser or a light-emitting diode, (LED), and is connected to said first connecting portion.

6. The sensor arrangement of claim 5, wherein said light sink comprises a light detector for detecting light emitted from said light source and is connected to said second connecting portion.

7. The sensor arrangement of claim 6, wherein said light source further comprises an optical fiber connected between said first connecting portion and said laser or said LED; and wherein said light sink further comprises an optical fiber connected between said second connecting portion and said detector.

8. The sensor arrangement of claim 6, said sensor arrangement further comprising means for recording the intensity of light detected by said detector.

9. The sensor arrangement of claim 8, further comprising computing means for computing the phase of a cryogenic fluid from said intensity of said light detected by said detector.

10. A cryogenic fluid delivery system comprising a source of cryogenic fluid, a conduit connected to said source of cryogenic fluid and a sensor arrangement connected to said conduit, wherein said sensor arrangement is a sensor arrangement of claim 1.

11. A system for cryogenic machining, said system comprising a machining tool connected to the cryogenic delivery system of claim 10.

12. Use of an optical sensor arrangement for detecting the phase of a cryogenic fluid in a conduit of a cryogenic fluid delivery system.

13. Use of claim 11, wherein the optical sensor arrangement is a sensor arrangement of claim 1.

14. Method of detecting the phase of a cryogenic fluid in a conduit of a cryogenic fluid delivery system, said method comprising detecting the phase of said cryogenic fluid in said conduit with a sensor arrangement of claim 1.

15. Method of controlling the mass flow of cryogenic fluid through a cryogenic fluid delivery system, wherein the mass flow is controlled on the basis of a signal detected by a sensor arrangement of claim 1.
